(19) United States
(12) Patent Application Publication
(10) Pub. No.: US 2018/0372900 A1
(43) Pub. Date: Dec. 27, 2018

(54) SYSTEM AND METHOD FOR ACQUIRING SEISMIC DATA WITH FLOTILLA OF SEISMIC SOURCES

(71) Applicant: CGG SERVICES SAS, Massy Cedex (FR)

(72) Inventors: Antoine LELAURIN, Paris (FR); Thierry BRIZARD, Ollainville (FR); Risto SILIQI, Paris (FR); John James SALLAS, Plano, TX (US); Benoît TEYSSANDIER, Massy Cedex (FR)

(21) Appl. No.: 15/781,832

(22) PCT Filed: Mar. 9, 2017
(86) PCT No.: PCT/IB2017/000347

§ 371 Date: Jun. 6, 2018

Related U.S. Application Data
(60) Provisional application No. 62/308,318, filed on Mar. 15, 2016.
(60) Provisional application No. 62/305,544, filed on Mar. 9, 2016.

(51) Int. Cl. G01V 1/38

(52) U.S. Cl. CPC G01V 1/3861; G01V 2210/1293; G01V 1/3817

(57) ABSTRACT

A seismic source system that includes a command vessel; a flotilla including plural unmanned surface vessels (USVs); and plural source elements configured to be deployed to a given depth in water to generate seismic waves. Each USV is connected through an umbilical to one or more of the plural source elements, and wherein the command vessel controls a shooting position and a shooting time of the one or more of the plural source elements.

### CROSS REFERENCE TO RELATED APPLICATIONS

The present application claims the benefit of priority under 35 U.S.C. § 119(e) to U.S. Provisional Application Nos. 62/305,544 filed on Mar. 9, 2016 and 62/308,318 filed on Mar. 15, 2016. The entire contents of these documents are hereby incorporated by reference into the present application.

### BACKGROUND

### Technical Field

Embodiments of the subject matter disclosed herein generally relate to methods and systems related to seismic exploration and, more particularly, to mechanisms and techniques for generating seismic waves with a flotilla of independent seismic source elements.

### Discussion of the Background

Marine seismic data acquisition and processing generate a profile (image) of a geophysical structure under the seafloor. This image is generated based on recorded seismic data. The recorded seismic data includes pressure and/or particle motion related data associated with the propagation of a seismic wave through the earth. While this profile does not provide an accurate location of oil and gas reservoirs, it suggests, to those trained in the field, the presence or absence of these reservoirs. Thus, providing a high-resolution image of geophysical structures under the seafloor is an ongoing process. The image illustrates various layers that form the surveyed subsurface of the earth.

During a seismic gathering process, as shown in FIG. 1, a vessel 110 tows an array of seismic receivers 111 provided on streamers 112. The streamers may be disposed horizontally, i.e., lying at a constant depth relative to the ocean surface 114, or may have spatial arrangements other than horizontal, e.g., variable-depth arrangement. Vessel 110 also tows a seismic source array 116 configured to generate seismic waves 118 (only one is shown for simplicity). The seismic wave 118 propagates downward, toward the seafloor 120, and penetrates the seafloor until, eventually, a reflecting structure 122 (reflector) reflects the seismic wave. The reflected seismic wave 124 propagates upward until it is detected by receiver 111 on streamer 112. Based on this data, an image of the subsurface is generated.

In an effort to improve the resolution of the subsurface's image, an innovative solution (BroadSeis system of CGGVeritas, Massy, France) has been implemented based on broadband seismic data. The BroadSeis system may use Sentinel streamers (produced by Sercel, Nantes, France) with low noise characteristics and the ability to deploy the streamers in configurations allowing the recording of an extra octave or more of low frequencies. The streamers are designed to record seismic data while being towed at greater depths and are quieter than other streamers. Thus, the receivers of these streamers are best used with a marine broadband source array.

A marine broadband source array may include one or more sub-arrays (usually three sub-arrays), and each sub-array may include plural source elements (e.g., an air gun or a cluster, association of several air guns, etc.) provided along a Y direction as shown in FIG. 2. This source array 250 has better characteristics than existing source arrays and it is disclosed in patent application Ser. No. 13/468,589, filed on May 10, 2012, and assigned to the same assignee as the present application, the entire disclosure of which is incorporated herein by reference. Source array 250 may include three different sub-arrays 260a-c, each having a corresponding float 252a-c, respectively. From each float a plurality of source elements 264 is suspended. A source element may be an air gun, water gun, vibratory element, etc. However, different from the existing sources, note that source elements 264 are suspended, from the same float, at two different depths, and the configuration of the source elements attached to one float may be different from the configuration of the source elements attached to another float. For example, FIG. 2 shows that sub-array 260a has the deeper source elements behind the shallow source elements along direction Y, while sub-array 260c has the deeper source element between the shallow source elements along the Y direction.

FIG. 3 shows in more detail a sub-array 300 of such source array. Sub-array 300 includes a float 302 from which multiple plates 304 are suspended at a given depth. Float 302 has a body that extends along a longitudinal axis (X). Cables 306 may be used to suspend the plates 304 from the float 302. Plural source elements 308a to 308e form the given depth sub-array set 308. All these source elements are suspended from the same float 302 via links 312 that substantially extend along a vertical axis (Z). Link 312 may include a chain, a rope and/or a cable. Each source element may have its own cables 314 (electrical, compressed air, data, etc.) for receiving commands or power (note that these cables are not shown for all the sources). The cables are protected by a rigid housing 315. Strength members 310 may be located between the plates 304 for maintaining the source's integrity when towed underwater.

Some of the source elements may optionally be connected to each other by various means 316, e.g., rods, chains, cables, etc. A front portion of the plate 304 corresponding to the first source element 308e (an air gun in this figure) may also be connected via a connection 318 to an umbilical 320 that may be connected to the vessel (not shown). Optionally, a link 322 may connect the float 302 to the umbilical 320. In one application, three or more such floats 302 and corresponding source elements may form the source array.

As seen from this description, the traditional source arrays are bulky, heavy, difficult to control and not flexible, i.e., the various source elements that make up the source array cannot move independent of the others. Note that the marine vibratory sources, in general, are much larger than impulsive sources like airguns because for the same size (by weight or volume), the vibratory sources emit much less energy. This fact further complicates the ability to tow, move and handle the vibratory sources in towed subarrays.

In addition, conventional marine seismic surveys are conducted by large seismic vessels towing long streamers equipped with hydrophone receivers. In many cases, these large seismic vessels also tow source arrays. In some cases, additional seismic source vessels are utilized to tow additional seismic sources, either to improve overall efficiency or to collect data sets at longer offsets. Recently, marine vibrators have been introduced, which in general have lower power than impulsive sources. Deployment, retrieval and towing of marine vibrators that are in large housings present significant challenges. Further, towing the source elements with a fixed geometry also limits the ways the vibratory sources can be utilized to fully exploit their potential benefits with regard to spectral output and spatial directivity over impulsive sources.

Another issue with moving marine vibrator source arrays is data smearing caused by Doppler shift effects at higher frequencies, which is particularly a problem when trying to image strongly dipping reflectors, for example the flanks of salt domes. Special model based processing techniques can be used to reduce this smearing effect, but generally, a priori knowledge of the subterranean features to be imaged is required.

A further limitation of the existing source arrays is that the acquired seismic data is not usually wide azimuth (WAZ). There is generally inadequate cross-line spatial sampling and not enough cross-line offset between the sources and receivers. WAZ data sets have the potential to provide clearer images of complex geologic features because acoustic energy from reflectors may be widely scattered and not collected by the towed streamer sensors. Another limitation with conventional marine survey geometry is that the sources are typically in front of the receiver lines, so this arrangement only allows for off-end shooting and no split-line shooting, i.e., the source being located near the middle of the receiver line.

Another receiver technologies like OBN (ocean bottom nodes) and OBC (ocean bottom cables) have opened up new methods for conducting seismic surveys, either for exploration or for reservoir monitoring using time-lapse (4-D) imaging. OBN are typically used in deep water (up to 3,000 m), but are expensive to deploy and maintain. Typically, the OBN receivers provide a sparse receiver spatial sampling of the seabed. By using more shotpoints, seismic surveys can be conducted that compensate for this sparse receiver sampling. In reservoir monitoring like time-lapse, surveys may be repeated every few months to locate the boundary between injected fluids and hydrocarbons in a reservoir or to estimate reservoir depletion. Difference displays of seismic images are commonly used to help estimate what has changed in the reservoir so that pumping schedules can be adjusted to maximize hydrocarbon recovery.

Therefore, there is a need for economically conducting a marine seismic survey using a flexible seismic source system that can be configured to meet different geophysical and operational objectives. A marine seismic source system that can be operated in conjunction with conventional seismic survey methods that use towed streamers, stationary receivers like OBC and/or OBN, and/or new receiver technologies that use autonomous small streamers would be of value. Moreover, a marine seismic source system that can be configured to (1) operate the source elements simultaneously, (2) use subsets of source elements with synchronized or phased emissions useful for beam forming and/or (3) operate simultaneously using signals that are pseudo-orthogonal and can be separated during processing and recombined as desired, would provide added value.

Therefore, it is desired to produce a flexible, reconfigurable source arrangement that overcomes the above discussed problems.

### SUMMARY

According to one embodiment, there is a seismic source system that includes a command vessel, a flotilla including plural unmanned surface vessels (USVs), and plural source elements configured to be deployed to a given depth in water to generate seismic waves. Each USV is connected through an umbilical to one or more of the plural source elements. The command vessel controls a shooting position and a shooting time of the one or more of the plural source elements.

According to another embodiment, there is a method for generating seismic waves in a marine environment. The method includes deploying a command vessel, deploying a flotilla including plural unmanned surface vessels (USVs), instructing, with a command and control module located on the command vessel, the plural USVs to move to desired water surface target positions, instructing, with controllers located on the USVs, corresponding plural source elements to move to desired underwater target positions, wherein the USVs are connected through umbilicals to one or more of the plural source elements, and instructing the plural source elements to shoot according to a given sequence. The command and control module controls shooting positions and shooting times in the given sequence of the plural source elements.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional marine seismic survey system;

FIG. 2 is an overall view of a marine source array having plural source elements connected to floats;

FIG. 3 is a schematic diagram of a traditional seismic survey source sub-array having all the source elements connected to a single float;

FIGS. 4A-4C illustrate a seismic source system that includes a command vessel and plural unmanned surface vessels (USVs) towing source elements;

FIG. 5A illustrates an USV towing a low-frequency source element;

FIG. 5B illustrates an USV towing a high-frequency dual source element;

FIG. 6 illustrates a source element attached to a corresponding frame;

FIG. 7 illustrates an USV;

FIG. 8 illustrates a command and control network of a flotilla of USVs;

FIG. 9 illustrates an USV controller;

FIG. 10 illustrates a command and control module located on a command vessel;

FIG. 11 is a flowchart of a method for generating seismic waves using plural independent source elements towed by USVs;

FIG. 12 illustrates a communication network between the USVs and the command vessel during source elements positioning;

FIG. 13 illustrates a communication network between the USVs and the command vessel during source elements shooting;

FIG. 14A illustrates a survey map, FIG. 14B illustrates a survey cell in one region, and FIG. 14C illustrates a survey cell in another region;

FIGS. 15A and 15B illustrate a sweep for a low-frequency source element;

FIGS. 16A and 16B illustrate a sweep for a high-frequency source element;

FIG. 17A illustrates an elementary source array and FIG. 17B illustrates a full source array;

FIGS. 18A and 18B illustrate source positioning for low- and high-frequency elementary source arrays;

FIG. 19 illustrates a linear source array;

FIGS. 20A and 20B illustrate various beam orientations of the linear source array;

FIG. 21 illustrates a selective source energy emission achieved with independent source elements;

FIG. 22 is a flowchart of a method for deploying plural source elements with a command vessel and plural USVs; and

FIG. 23 is a schematic diagram of a controller.

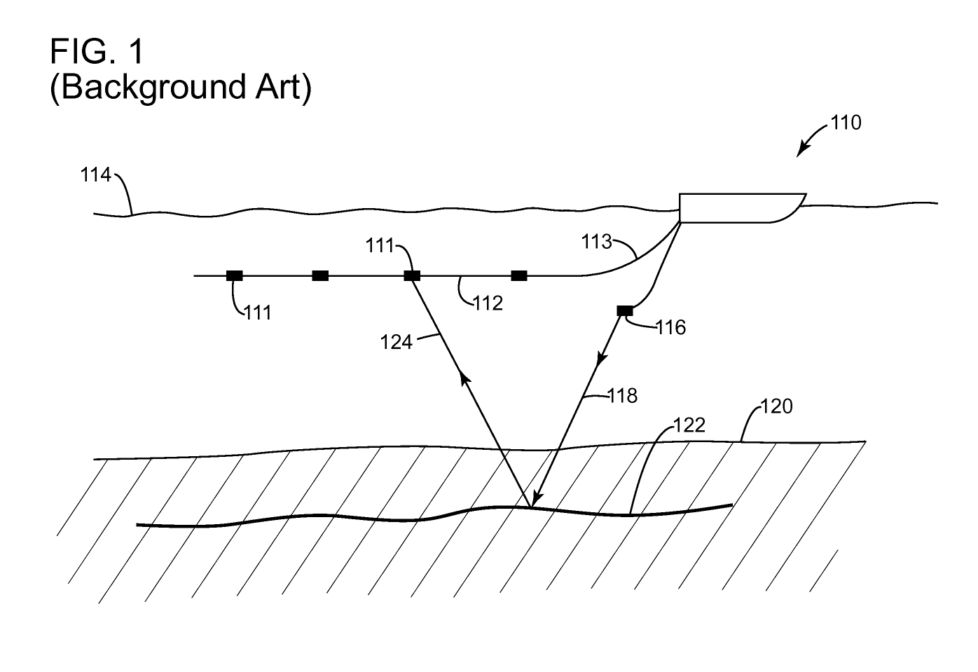

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a seismic source system that includes a command and control vessel and a flotilla of at least one unamend surface vessel linked to a marine vibrator. However, the embodiments to be discussed next are not limited to marine vibrators, but may be applied to other types of seismic sources.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a seismic source system that includes a command and control vessel (CCV) and a flotilla of at least one unmanned surface vessel (USV). The USV is linked to at least one marine vibrator. The marine vibrator is attached to a carrier that may include a propulsion unit to enable precise source positioning. In one application, the CCV has a flotilla command and control manager (FCCM) that includes a scheduler-dispatcher module to set/adjust: the shooting schedule of the marine vibrators, sweep parameters and positions of each acoustic vibrator (also called acoustic projector). This system can be adapted, operated and/or configured to meet particular geophysical objectives subject to operational and economic considerations. Geophysical objectives may include image quality, spatial resolution, noise mitigation, and survey repeatability.

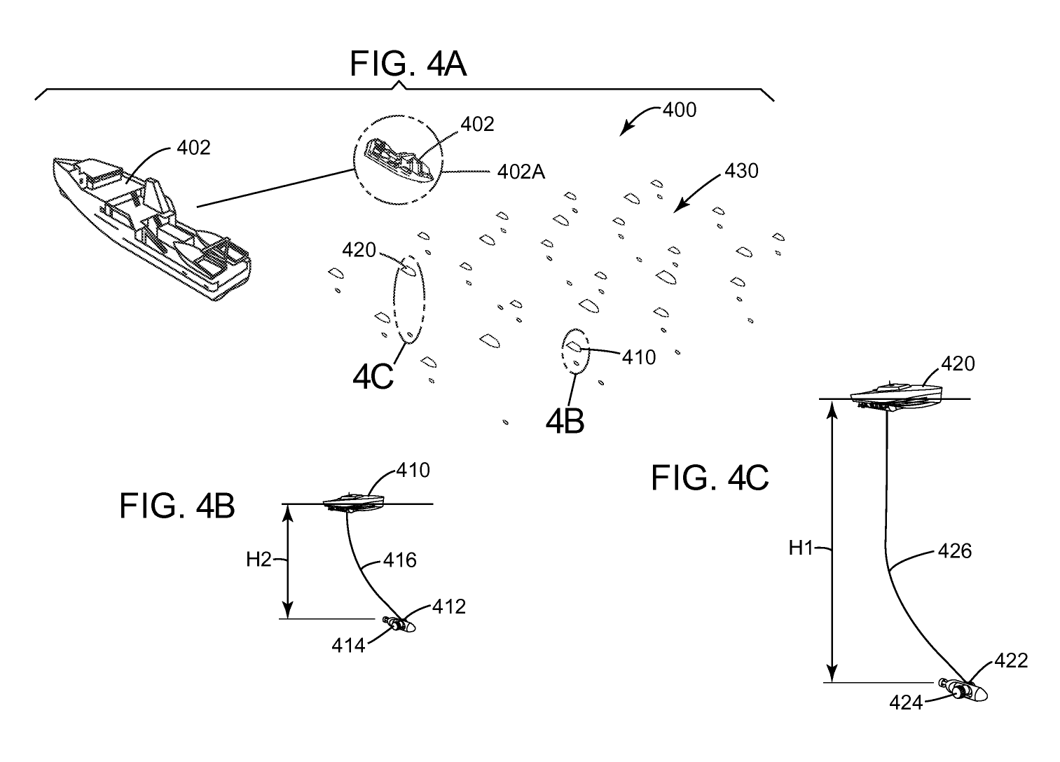

According to an embodiment, a seismic waves generation system 400 (or seismic source system) includes a CCV 402 and a flotilla 430 of USVs, where one or more of the USVs 410, 420 is connected to one or more corresponding source elements, as illustrated in FIG. 4A. USV vessel 410 is shown in FIG. 4B as being connected to a carrier 412, to which a source element 414 is attached. For this specific embodiment, source element 414 is a high-frequency (HF) source element. A cable 416 connects USV vessel 410 to source element 414 and/or carrier 412. Cable 416, called umbilical herein, may include a communication cable (coaxial, wire, or fiber optic). The umbilical may also contain wires for power, pneumatic and/or hydraulic lines and include a strength member (for example, wire rope or Kevlar). FIG. 4C shows USV vessel 420 being connected to carrier 422, to which source element 424 is attached. In this embodiment, source element 424 is a low-frequency (LF) source element. Cable 426, similar to cable 416, connects the USV vessel 420 to source element 424 and/or frame 422. Those skilled in the art would understand that the seismic waves generation system 400 may include only LF elements, only HF elements, a mixture of LF and HF elements, or sources that generate both LF and HF frequencies. For illustrative purposes, the figures herein show an LF source element and a HF source element. However, the seismic source system may include two or more USV vessels having identical source elements.

An USV is loosely coupled to at least one seismic source element (i.e., acoustic projector or air gun) through umbilical 416 or 426. In an embodiment, carrier 412 and/or 422 is capable of self-propulsion. In an embodiment, the seismic source element is a marine vibrator, for example, a twin-driver as disclosed in U.S. Pat. No. 8,830,794.

The size of the USV vessel may vary as the source element is an LF or HF element. For example, an HF element is smaller than a LF element, and thus, in one application, USV vessel 410 may be about 6 m long while USV vessel 420 may be about 9 m long. For comparison reasons, CCV vessel 402 may be about 40 m long. CCV vessel may transport one or more USVs or source elements on its deck. Other sizes for the CCV and USV vessels may be used.

One reason for using two or more types of source elements, for example, an LF vibrator and a HF vibrator, is the efficiency of the overall system. The LF may be capable of generating signals in the range of about 4-32 Hz efficiently, while the HF may be capable of covering the frequency range of about 25-125 Hz. Other frequency ranges are possible. To further improve efficiency, the LF and HF may be operated at different depths, for example about 25 m and about 5 m, respectively, to avoid the destructive interference of the echo from the sea surface, or, in one application, to take advantage of the constructive interference with the echo from the sea surface. FIG. 4C shows the LF source element 424 linked to USV 420 and located at a depth H1 of about 25 m. FIG. 4B shows HF source element 414 linked to USV 410 and located at a depth H2 of about 5 m.

FIG. 4A shows that each USV of the flotilla 430 is linked to a corresponding source element (LF and/or HF vibrator in this embodiment) and each USV is in communication with CCV vessel 402. Although the following embodiments are discussed with regard to marine vibrators being the source elements, the invention is not limited to this type of source. For example, impulse sources like air guns or water guns are also possible. Also, in the description below, the term “sweep” used to describe the actuation of the source element, is defined as the acoustic signal emitted by the marine vibrator. A sweep can be a swept sine wave (linear or nonlinear), a phase encoded swept sine wave, a pseudorandom signal, a discrete frequency emission, an arbitrary waveform, or a combination of signals not limited to a series of encoded concatenated swept sine waves. Also, more than one sweep may be executed by a source element at a given shotpoint location (or in proximity to a shotpoint location including sweeping while moving between shotpoint locations) for noise reduction and/or stacking (for example, vertical stacking or diversity stacking) as records from repeated sweeps at a particular location can be used to reduce noise. A shotpoint location references the coordinates of a point or center point where a source element or array of sources sweeps. If the source element is moving during a sweep, then the shotpoint location includes the coordinates corresponding to the center point of the source element path during its sweep.

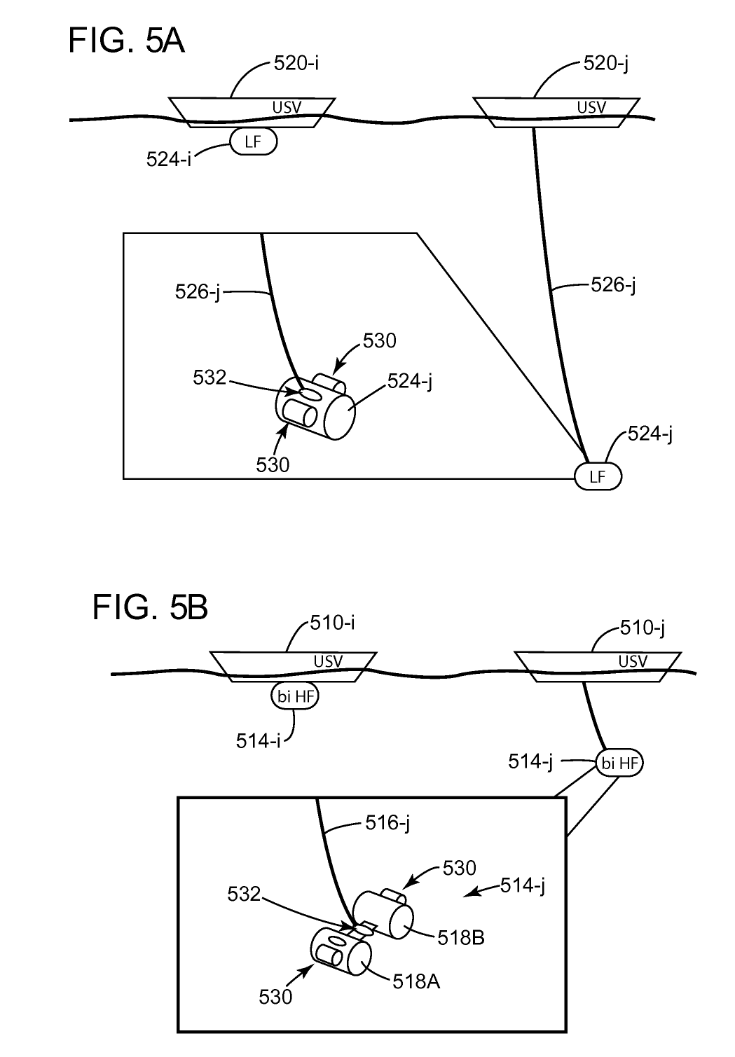

FIGS. 5A-5B show in more detail the interconnection between an USV and its source element. Although this embodiment shows each USV having a single source element, it is possible that an USV has plural source elements. FIG. 5A shows a USV 520-i having a corresponding LF source element 514-i and another USV 520-j having its corresponding LF source element 524-j. USV 520-i has the source element in a retracted position (i.e., the source element is located at substantially at the same depth as the USV and cable 526 is rolled up inside the vessel or the source) while USV 520-j has the source element 524-j in a deployed position (i.e., the source element is located at a depth different from a depth of the USV and cable 526-j is extending to the depth of the source element). The same is true for the HF source element, as illustrated in FIG. 5B.

In an embodiment, the LF source element 524-j may actually contain two or more linear actuators that each drive an acoustic piston, with their operation synchronized so that both pistons move in and out together to create a twin-driver. This kind of source element is described in U.S. Pat. No. 8,837,259, assigned to the assignee of this application. In an embodiment, as illustrated in FIG. 5B, USV 510-j may actually carry two HF twin-drivers 518A and 518B because these units are smaller than the LF source elements and using two twins together will increase the overall acoustic output of the source element 514-j. The twin-driver or its carrier (not shown in these figures) may be equipped with a position-sensing module 532. The position-sensing module 532, which may also be present on the LF source element of FIG. 5A, may utilize sensors like a compass, accelerometers, gyroscopes and/or ultrasonic transceivers to determine the position of the source element(s) relative to the USV's location. In another embodiment, a single USV may be linked to an LF twin-driver and two HF twin-drivers. Other combinations of source elements may be attached to a single USV.

The measured source element's position information can be recorded and retained for later use in data processing of the reflection data set. In instances where it is not necessary to precisely control the source element's position, the position of the USV is controlled in combination with schemes to manipulate the umbilical via a winch or other means (not shown) to adjust or hold the source element in an approximate location.

In an embodiment, one or more thrusters 530 may be attached to the source element or to the source element's carrier to maintain the relative position of the source element with respect to the USV and/or depth as the USV moves, and to also help maintain a precise position during swells. The use of thrusters is also helpful if the source element is to be operated while moving, for example, as it advances to the next shotpoint. The thrusters may use electrical power or compressed air provided by umbilical 416 or 426 for moving a mass of water in a certain direction to achieve a moving of the source element in an opposite direction.

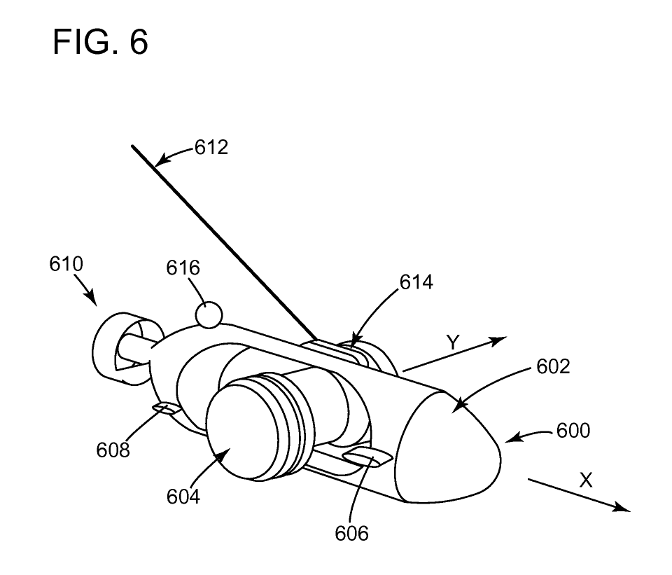

FIG. 6 illustrates a source carrier 600 (carrier herein) that has a platform 602 for housing one or more of the source elements. Source carrier 600 is loosely coupled to a corresponding USV through umbilical 612, which includes means for two-way communication (e.g., electrical cable), a strength member for supporting the weight of the carrier and the source element, and means suitable for power transmission (hydraulic hoses and/or wires). The carrier houses, propels, and steers the associated source element. Twin-driver 604 (the source element in this embodiment) is installed and allowed to pivot inside platform 602 using pivot actuator 614. This means that twin-driver 604's longitudinal axis is aligned to the carrier's longitudinal axis X while the USV is traveling to its destination, after which, the pivot actuator 614 (e.g., an electrical or hydraulic motor) rotates the twin-driver to have its longitudinal axis along direction Y, which is perpendicular to longitudinal axis X, as illustrated in FIG. 6. This is for allowing the generated seismic waves to freely propagate away from the carrier 600, without being attenuated by the platform 602.

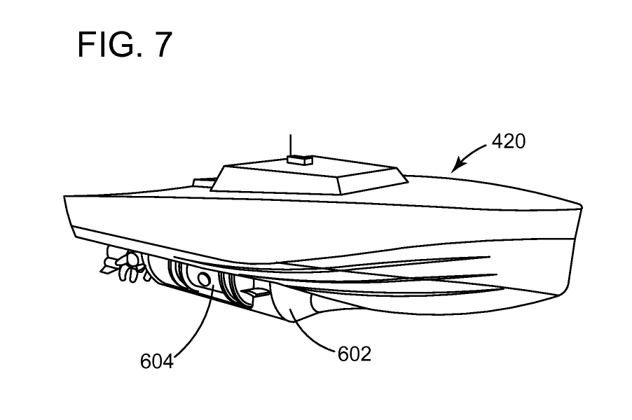

Carrier 600 may be equipped with a self-propulsion unit 610 (in this case a housed propeller driven by an electric motor). Steering means using control surfaces 608 (e.g., a rudder) and 606 (e.g., a wing) for pitch and yaw adjustment may also be mounted to platform 602. Carrier 600 may also be equipped with a position-sensing module 616 that in an embodiment contains a 10-axis IMU (inertial measurement unit) and/or a depth sensor and/or an acoustic measurement device. Carrier 600 may be equipped with other features to reduce drag (for example, a streamlined shape) or to improve handling performance. In one embodiment, carrier 600 may include a buoyancy control device (not shown) to help maintain a certain depth. In an embodiment, a sea anchor, not shown, could optionally be deployed by platform 602 to help stabilize the source element's position. In one application, the source element 604 and/or platform 602 can be retracted and clamped within a corresponding USV for transport to the underside of the USV as shown in FIG. 7. Other transport configurations are possible.

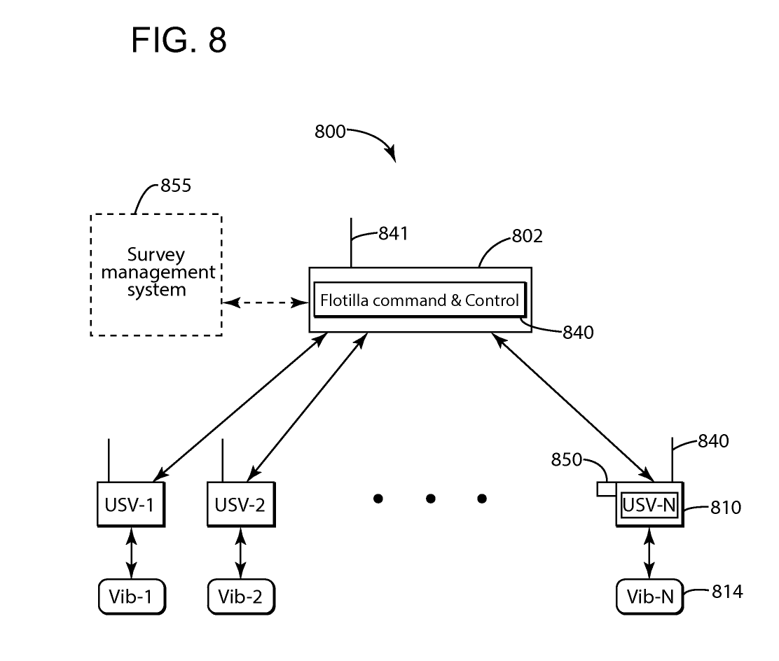

Having discussed the various components of the flotilla, communication signals exchanged by these components are now addressed. FIG. 8 illustrates the command and control network 800 for the flotilla. The CCV vessel 802 and all USVs 810 may be equipped with GPS positioning/time receivers. A flotilla command and control module (FCCM) 840 may be located on the CCV 802 and this module stores the survey information including the shotpoint schedule. The FCCM module may be implemented in a computing device, which is discussed later. The shotpoint schedule is a table stored in the memory within the FCCM and the table may contain: the source emission locations, sweep parameters, survey path and shot order for each USV/source element.

The CCV and USVs are each equipped with a transceiver 841 (e.g., a bi-directional wireless device that can transmit and receive data through electromagnetic or acoustic waves) so that the FCCM can track the progress of each source element within the survey and the USVs can report the current positions of their source elements and also whether or not they are in position. Other information, for example, fuel status, vibrator performance or quality control data can be communicated from the USVs to the FCCM. The FCCM will also ensure that all components of the system are synchronized.

Each USV may have an onboard controller 850 that acts like an automatic pilot for both the USV and its associated source elements. Onboard controller 850 (e.g., a computer) may include a source manager module that is configured to autonomously drive the USV from one shotpoint to another shotpoint, after instructed as such by the FCCM. If the flotilla operates in conjunction with another seismic survey system, which also utilizes moving sources and/or receivers, a bi-directional link allows for communication between the FCCM and the survey management system (SMS) 855. SMS 855 has access to the positions of the other source and receiver elements, which are not part of the system 800, and SMS exchanges information with the other survey to avoid interference (for example entanglement or collision) and to maintain the desired geometry between sources and receivers to achieve: favorable target illumination, adequate spatial sampling and signal fidelity. SMS 855 may be physically located on CCV 802, on land, or on another vessel.

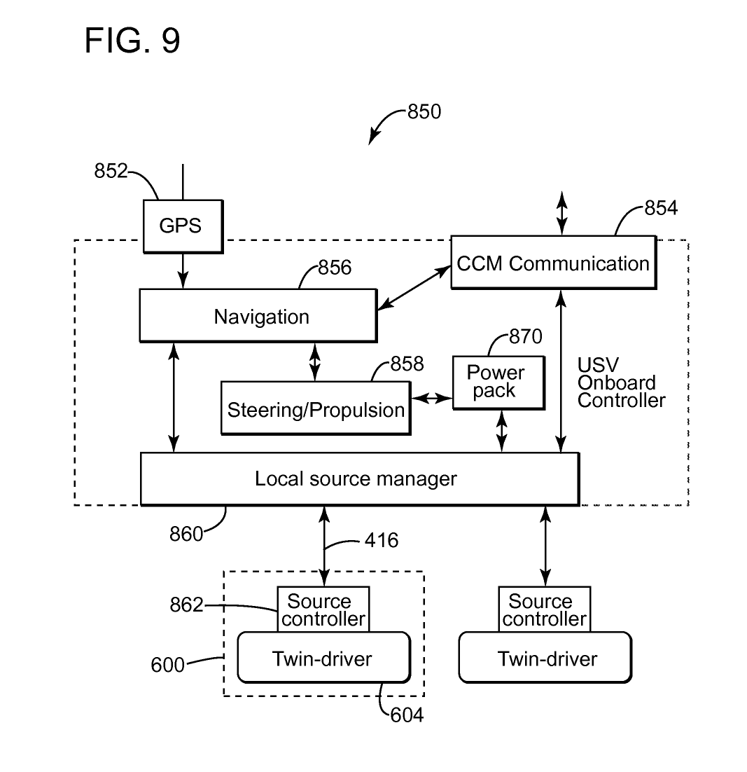

A possible configuration of USV's onboard controller 850 is illustrated in FIG. 9. Onboard controller 850 may include or communicate with a GPS 852 for receiving location coordinates. Onboard controller 850 also receives commands from the FCCM, via the aforementioned wireless link, through a CCM communication module 854. Those commands fall into two categories: navigation and source operation. A navigation module 856 receives both the GPS location coordinates and time from the GPS receiver 852, and shotpoint position information from the CCM 854. Navigation module 856 interfaces with a steering and propulsion system 858 to either direct the USV to a new position or to maintain a current position. The CCM communication module 854 may also receive sweep parameter information and/or sweep timing information that is passed along to the local source manager module 860, which is in bi-directional communication, through umbilical 416 or 426 with the source element controller 862. The source element controller 862, which can be attached to source element 604 or platform 602 in FIG. 6, can pass the source status and quality control information back to the local source manager module 860, and this information can be relayed back to the FCCM through the CCM communication module 854. If more than one twin-driver source element 604 is used, then the local source manager 860 can be configured to communicate with a plurality of source controllers 862. FIG. 9 also shows that the USV onboard controller may include a power pack 870 for supplying power to the above discussed modules. In one embodiment, power pack 870 is located outside the onboard controller.

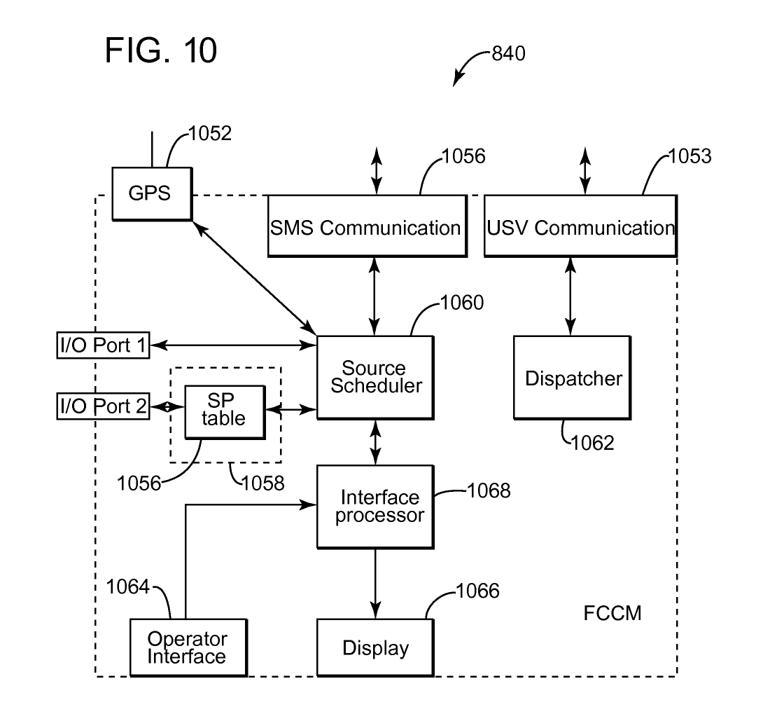

The FCCM 840 may have various configurations, one of which is illustrated in FIG. 10. FCCM 840 is located on the CCV and includes several modules with their functions described as follows. Note that a module may be implemented as software in a processor or as dedicated circuitry configured for achieving its intended function. FCCM 840 may include a GPS unit 1052 (or a GPS interface that communicates with a GPS unit) for receiving location information and/or GPS time. While the information from the GPS unit may be used for navigation of the CCV, it is intended to acquire GPS time to maintain proper coordination of the overall operation of the entire flotilla. The USV Communication module 1053 is used to provide a wireless bi-directional communication data link between the FCCM and the fleet of USVs. Information to be exchanged between the USVs and FCCM may include, but is not limited to: shotpoint coordinates, current source element location, timing information, sweep parameters, the number of sweeps to be emitted at a shotpoint, source element status information, quality control information and other USV information like fuel levels. If the flotilla is to be used in conjunction with other sources and/or moving receivers, then an SMS communication module 1056 is present to exchange information with the SMS 855. This information is useful for coordinating the flotilla's operation with the external sources and/or receivers. A shotpoint table 1056 (that details the shooting time and positions for each source element) may be located in a memory 1058 and contains the shotpoint locations and shooting order ascribed to each USV along with the source sweep parameters to be utilized at that shotpoint. The shotpoint table can be loaded via I/O Port 2 using parameters determined beforehand in a survey plan.

A source scheduler module 1060 acts as the administrator of all this information, receiving GPS time, USV source status/position information, external source/receiver information from the SMS, and it uses this information to calculate the next source element position to be occupied by a USV and to determine whether or not a source element is in position to sweep or not. After a determination is made by the source scheduler module 1060, the information is passed to a dispatcher 1062 where it may be buffered and coordinated with other USV information for transmission through the USV Communication module 1053 to each USV. Information available to the source scheduler module 1060 can be selected for viewing by the operator through an operator interface 1064 (for example, a keyboard, joystick, mouse or touch screen) and the information may be displayed on a display 1066 in a suitable format, through use of an interface processor 1068. Items for display may include, but are not limited to: present, past or future locations of the flotilla elements, source performance information, system status information, survey progress and other useful statistics. The operator interface 1064 also allows the observer to override the source scheduler module 1060 and/or modify the survey plan if required, for example, to redirect a USV to a preferred location for refueling or servicing if there is a source breakdown.

The internal communications between the various components in the FCCM 840 can be carried out using various schemes, for example, with information transferred using a serial bus or a parallel bus. In another embodiment, the internal communication link can be organized, for example, as a LAN (local area network) configured as an Ethernet star network where the source scheduler is the hub. In other embodiments, the LAN could be configured using a ring or mesh architecture. Other network schemes are possible. Fiber optic, wires, coaxial cables or wireless means can be used to carry the signals.

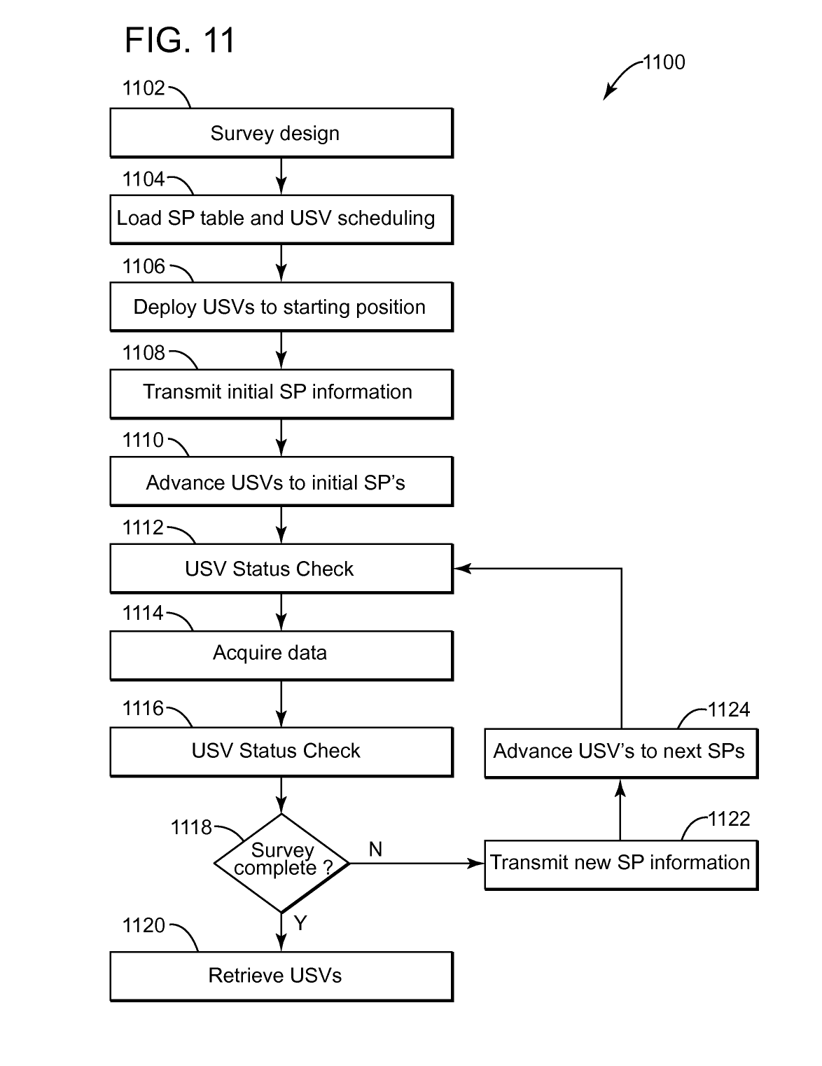

A method 1100 that details how the flotilla system discussed in the previous embodiments is used to generate seismic waves is now explained with regard to FIG. 11. For simplicity, it is assumed that the seismic receivers (may be streamers, OBC or OBN, independent receivers that float in the water column, etc.) have already been deployed and FIG. 11 only addresses the utilization of the flotilla of USVs for the data acquisition process. As part of the seismic survey design, which is performed in step 1102, the desired spatial sampling, shotpoint locations, sweep parameters and receiver positions of the source elements are typically computed at a land facility, prior to the actual survey, to meet the client's requirements and imaging objectives. There may be hazards and infrastructure (for example, drilling platforms) that may need to be taken into consideration in the survey design. The survey design output parameters include: flotilla shotpoint locations, sweep parameters and shooting schedule. These parameters are loaded in step 1104 into the memory of the FCCM, for example, into the shotpoint table and/or source scheduler previously discussed. Subsequently, or in parallel, the flotilla of USVs are deployed in step 1106 to their starting positions. The USVs can be deployed from a large vessel or a barge or even from a wharf or boat ramp if the survey area is not too far from land. Next, the FCCM sends in step 1108 the first shotpoint locations and sweep parameters to be used by each source element to each USV. The USVs advance in step 1110 to their respective first shotpoint and deploy their source elements to the specified depth. Subsequently, the USV's are polled in step 1112 for their status. Status data can include information about whether a source element has been deployed and is ready to sweep. Other status information might include fuel levels, temperature, pressure, source performance information. When the FCCM detects that a USV source element is in position and ready to sweep, it can send a command to the USV to begin sweeping or it can send a GPS time to begin sweeping. The command may require a start delay due to cross-talk from other source elements or, in the case of moving receivers, waiting for the receivers to move to their designated locations. The command may require a start delay due to other concerns. Other sweep initiation timing control schemes are possible.

The USVs start in step 1114 sweeping and generating seismic waves. The reflections of the seismic waves are recorded by the receiver data acquisition system also in step 1114. During the sweep, source elements performance data is collected in step 1116 to ensure adequate signal fidelity. Performance data typically includes position error, phase error, amplitude error and signal distortion information. After each emission interval (after completing all the sweeps at a particular shotpoint), the USV is polled for its status in step 1116 by the FCCM. If the USV's performance is satisfactory but the survey is determined in step 1118 to not be complete, the FCCM sends in step 1122 the new shotpoint location and sweep parameters to the USV's local controller. The USV then moves in step 1124 to its next shotpoint location and when polled for status in step 1112, it indicates whether it is ready for the next shot or not. This process repeats until the entire flotilla shotpoints have been executed. When all the shotpoints of the flotilla have been performed, the USVs are directed in step 1120 to a collection point where they are retrieved.

The flow chart in FIG. 11 is a general overview of the seismic waves generation process, but under some conditions, a shotpoint may need to be repeated if, for example, a particular source element malfunctioned. In this case, an operator may override the source scheduler or the source scheduler could autonomously reassign a different USV to travel to the shotpoint originally assigned to a different USV. Thus, although provisions for manual override are assumed during a seismic survey, they are not shown in this simplified flow chart.

The description of method 1100 assumes that the source elements are activated only when the USV is stationary. However, in one application, the source elements may be sweeping while the USV is moving to a new location and the flowchart shown in FIG. 11 can be modified to accommodate a moving source mode. A moving source element is less an issue for LF operation because any smearing due to the Doppler shift effects will be much less significant than for a HF source element.

In an embodiment, the USVs may work in tandem with other USVs so that their respective source elements form a source array. Because in this mode of operation the source elements are operated in close proximity to one another, resulting in a danger of entanglement and/or vessel collision, extra precautions and rules may be required (not detailed herein) to ensure safe operation.

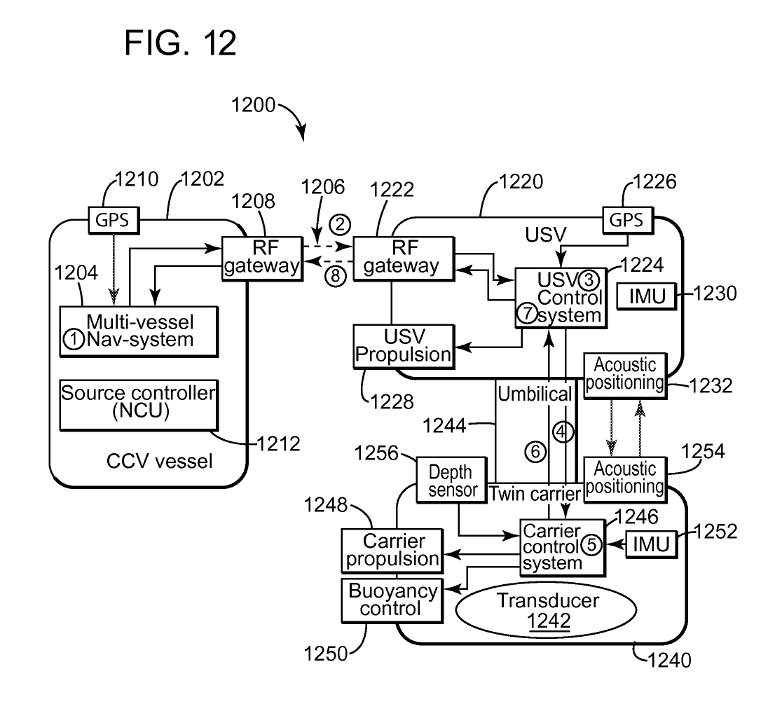

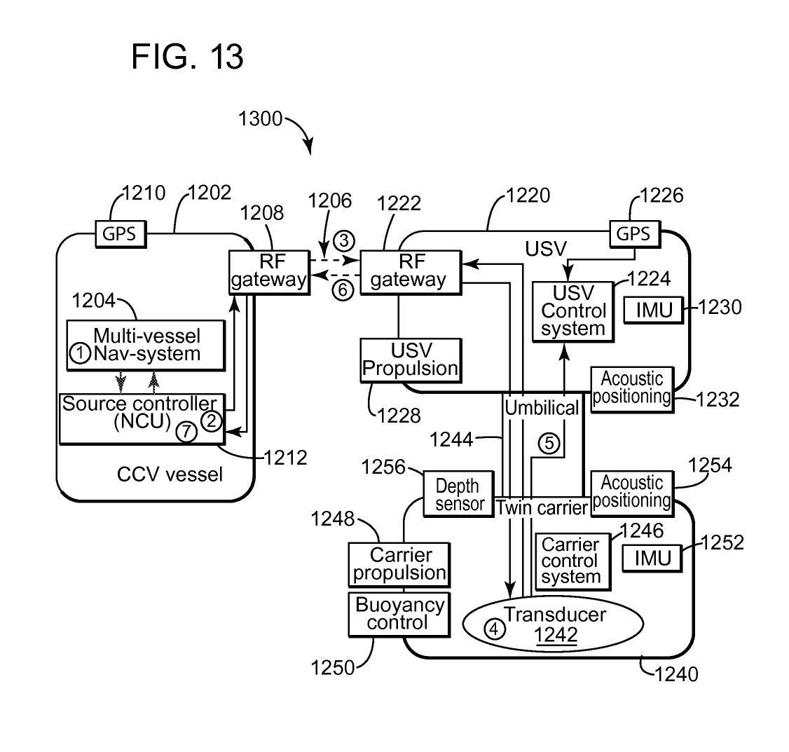

In another embodiment, the source elements are equipped with self-propulsion means (e.g., thruster as discussed with regard to FIGS. 5A and 5B) for accurate positioning. FIG. 12 shows a detailed schematic of a CCV-USV network used for source element positioning and FIG. 13 shows the same network when the source element is emitting.

Referring to FIG. 12, the seismic waves generation system 1200 is shown having CCV 1202, USV 1220, and corresponding source element 1242 (or carrier 1240). System 1200 includes a flotilla of USVs, but for simplicity, only one is illustrated in the figure. The following sequence of events occurs during the source-positioning phase of operation.

The CCV follows a pre-defined survey plan. A multi-vessel navigation system 1204 (can be a module implemented in software in the controller of the CCV or a hardwired circuit) computes in step 1 the required emission position for each source element and converts these positions into way points/routes. Multi-vessel navigation system 1204 may receive information from a GPS unit 1210 and also may communicate with a source controller 1212 (previously described with regard to FIG. 10 as a source scheduler 1060). The multi-vessel navigation system 1204 sends in step 2 to each USV 1220 its expected source element position(s), in the form of way points/routes, through a radio frequency (RF) link 1206. This link is established between RF gateway 1208 located on the CCV and a matching RF gateway 1222 located on the USV. The USV's controller 1224, based on its GPS position received from GPS unit 1226, attitude information, acoustic positioning of the carrier, and depth of the carrier, computes in step 3 the following quantities:
a) the position of the source element's carrier,
b) a displacement vector for the new position of the USV and then activates a propulsion system in order to remain within a defined distance from the carrier, and
c) a displacement vector for the carrier to reach its expected new position. If the USV has to move to the new position, the USV either retracts the source and carrier inside and then moves to the new position, or, if the new position is close, the USV coordinates the movement of the carrier so that the two move in tandem to the new position.

Note that for determining the position of the carrier 1240, USV 1220 may have an IMU 1230 (similar to IMU 616 illustrated in FIG. 6) and carrier 1240 may have its own IMU 1252. Alternatively or in addition, USV 1220 may have an acoustic positioning device 1232 and carrier 1240 may have a similar acoustic positioning device 1254. To improve the positioning of the carrier, a depth sensor 1256 may also be located on the carrier and measurements from this sensor may be provided to controller 1246 and/or controller 1224. After these calculations are performed, the USV's controller 1224 sends in step 4 the correction vector to the carrier 1240 through the umbilical 1244.

The carrier's control system 1246 calculates, based on the correction vector and its attitude information, the required propulsion activation signals and activates in step 5 the propulsion system 1248, and eventually the buoyancy control device 1250.

The carrier's control system 1246 reports in step 6 its status to the USV's controller 1224 along with its depth and attitude information, through the umbilical 1244. The USV's controller 1224 continues to monitor and control the carrier's position, as well as the USV's position by sending appropriate signals in step 7 to the USV's propulsion system 1228, in closed loop. The USV's controller 1224 sends in step 8 the position information of the carrier and the USV through RF link 1206 to the multi-vessel navigation system 1204. Optionally, each USV/carrier can be equipped with an obstacle detection system. In this case, the USV controller will only avoid collision, and report the obstacle presence to the multi-vessel navigation system, which will adapt the survey plan.

FIG. 12 discussed above illustrated a sequence of events that may occur during the source-positioning phase of operation. FIG. 13 illustrates another embodiment that describes a sequence of events that may occur during an emission interval, i.e., when the sources are fired. All the elements in FIG. 13 that were presented in FIG. 12 are labeled with the same reference numbers.

Method 1300 in FIG. 13 starts at step 1, in which, for each emission point, the multi-vessel navigation system 1204 checks that the positions of the source elements 1242 involved in the emission are within a required error margin of their expected positions. If a result of this checking is in the affirmative, then the multi-vessel navigation system 1204 sends a fire order to the source controller 1212. The source controller 1212 computes, in step 2, for each source element involved in the emission, a list of pilot signals to be applied, along with the expected amplitude level, phase offset and start time.

In step 3, the source controller 1212 sends to each source element, via RF link 1206 and then umbilical link 1244 the following information:

a) Synchronization signals,
b) List and time of signals to be played, along with the expected amplitude level and phase offset, and
c) Fire orders.

In step 4, the source element's control system (local controller located within the source element carrier or element 1242) performs the following functions:

a) Ensures synchronization with the global source controller 1212,
b) Stores the signals to be played, along with the expected gain and phase delay,
c) Actuates the source element to generate the sound emission following the fire order, and
d) Monitors sensor signals during the emission.

The source element sends in step 5 an emission status report to the USV control system 1224, along with alerts to trigger any emergency procedure. The source element further sends in step 6, to the global source controller 1212, through the umbilical 1244 and the RF link 1206, one or more of the following pieces of information:

a) Acknowledgements of source controller orders,
b) Status of the execution of orders, and/or
c) Sensors information.

The global source controller 1212 monitors in step 7 the execution of the emission, then computes required QC information (e.g., phase error, amplitude error, harmonic distortion, position error) and seismic deliverables (SEG-D) (e.g., source element piston acceleration signal and/or the piston acceleration signal correlated with a pilot signal or reference signal) and then the global source controller 1212 reports to the navigation system 1204 the status of the execution of the emission.

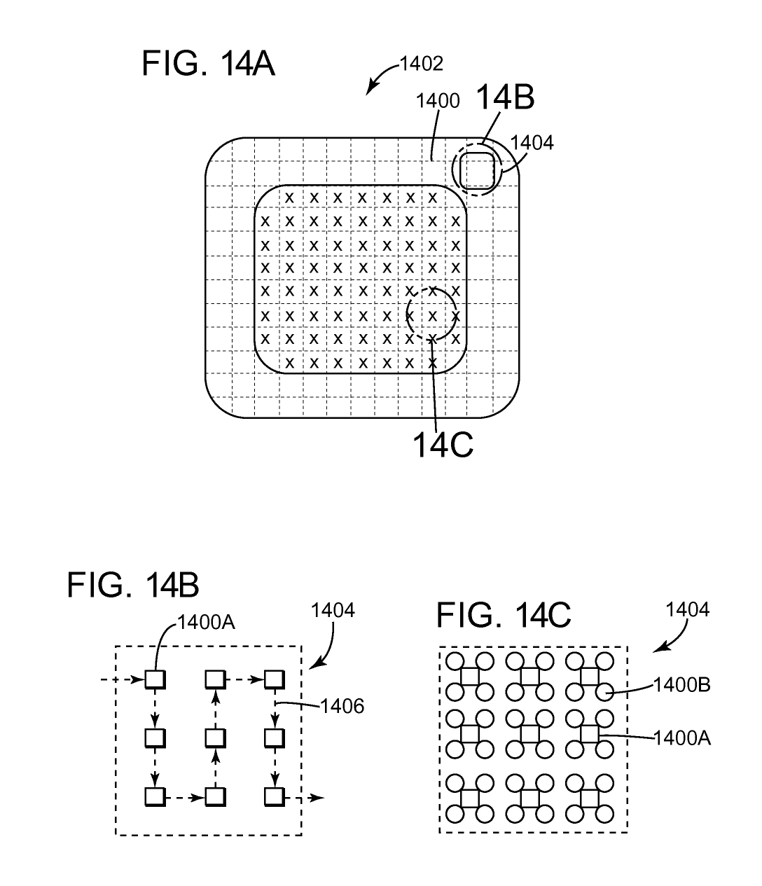

An embodiment that illustrates how the source elements are distributed over a subsurface to be surveyed is now discussed with regard to FIG. 14A. For example, in reservoir monitoring, time-lapse (4-D) techniques are often employed to detect changes in reservoir properties. In these applications, repeatably recording the seismic data over the same subsurface is desired because the different data sets, after being processed, indicate reservoir changes over time. Stationary sources and stationary receivers are better suited to 4-D work than moving sources and receivers.

A bird's eye view of an area 1402 to be surveyed has a plurality of receivers (in this case OBN) denoted by “x” as illustrated in FIG. 14A. The OBN are located on the seabed. The OBNs are capable of continuous recording and are typically equipped with batteries that can last 30 to 60 days. For purposes of describing this embodiment, it is assumed that these OBNs have already been deployed. Also, it is assumed, for simplicity, that the seismic waves generating system has only two types of USVs, a first type towing corresponding LF vibrators and a second type towing corresponding HF vibrators.

As part of the survey design, source locations (shotpoints) 1400 have been selected to meet the desired spatial resolution requirements to ensure acceptable image quality. It has been determined that the survey area 1402 can be divided into two regions, an outer region (Region A) that has a more distant offset from the receivers OBN and inner region (Region B) that lies at a closer offset. Note that survey area 1402 can be divided into more regions. Typically, seismic data acquired at long offset has little, if any, high frequency content. Thus, to improve productivity, shotpoints in Region B will only require low-frequency acoustic energy for imaging. In general, low-frequencies can be recovered without spatial aliasing issues using a coarser shotpoint grid (see FIG. 14B, shotpoints 1400A and path 1406 followed by the source element) than what is required for high-frequency recovery. FIG. 14C shows the desired shotpoint locations 1400B for high-frequency source emissions. FIG. 14C also shows the shotpoint locations 1400A for the low-frequency source emissions. Note that FIG. 14A has a survey grid overlay imposed upon it. This overlay grid divides the survey up into operation cells 1404. FIG. 14B shows an operation cell within Region A and FIG. 14C shows an operation cell within Region B. Within each operational cell lies a plurality of shotpoints.

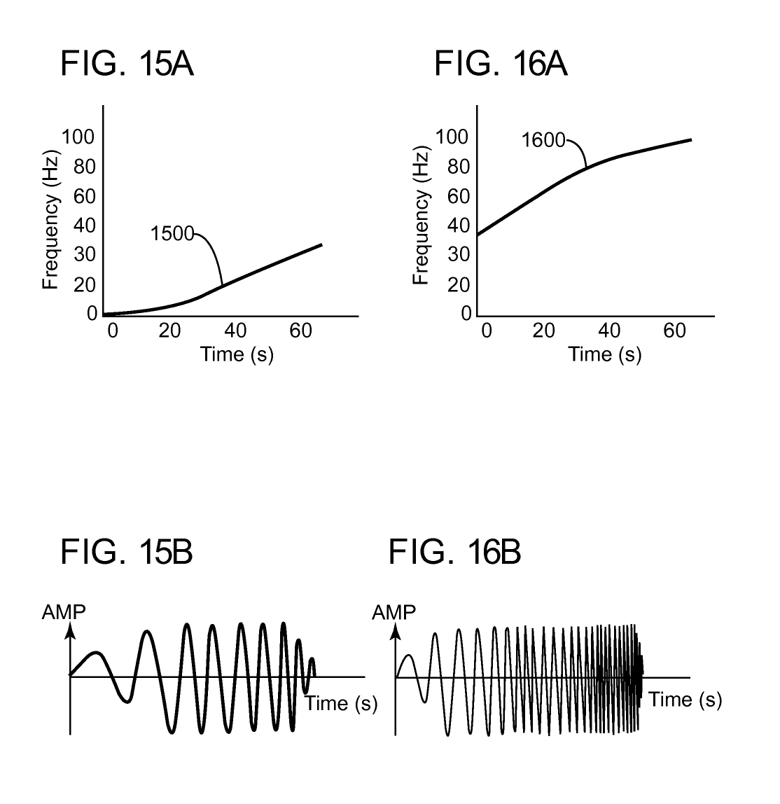

In an embodiment, a plurality of USV/LF units (for example eight LF source elements towed by eight corresponding USVs) is deployed along with a plurality of USV/HF units (for example 16 HF source elements towed by 16 corresponding USVs). The source elements are all managed by the CCM. The LF source elements use a low-dwell swept sine wave (see curve 1500 in FIG. 15A represented as frequency over time or in FIG. 15B represented as amplitude over time) and the HF source element uses a high-dwell sweep (see curve 1600 in FIG. 16A represented as frequency over time or in FIG. 16B represented as amplitude over time). The LF sweep 1500 has a frequency range of 4-32 Hz and the HF sweep 1600 covers the frequency range of 32-125 Hz. Other frequency ranges may be used. In this example, both LF and HF sweeps are 64 s in duration.

In this embodiment, the source elements are operated in a slip sweep mode, where the slip time is chosen to minimize the potential for interference within the listen time of the different source elements (depends upon the depth of the target to be imaged and the two-way travel time for the reflected energy). For this specific embodiment, to avoid collisions between the source elements, the shotpoint schedule allows only one USV to operate within an operational cell at a time. Typically, the USV follows a serpentine path (see path 1406 in FIG. 14B) as it moves from one shotpoint 1400A to the next within a cell 1404, before entering an adjacent cell. In normal operations, the USV moves to a shotpoint 1400A, informs the CCM that is stationary and in position ready to sweep, and the CCM sends a unique start command or delayed start command to that particular USV, depending upon the status of the other USV/LFs and USV/HFs.

For this embodiment, if there are 8 LFs, a 64 s sweep, and a listen time of about 6 s, it is possible to have a slip time of about 7 s, with a window of +/−1 s. At the same time, there are 16 HFs operating in Region B, also employing 64 s sweeps. Because due to absorption effects, high-frequencies in general do not penetrate very far, it can be assumed that a shorter listen time of about 3 s is adequate for the higher frequency data set. Thus, for this embodiment, the slip time for the HF sources could be 4 s+/−1 s.

In a different embodiment, other sweep encoding schemes, instead of slip sweep, could be used to produce emissions that can be separated. For example, orthogonal pseudorandom sweeps, concatenated phase encoded sweeps, different sweep rates, time-scheduled narrow band sweeps and other schemes may be used.

As time progresses, the source elements work their way through the survey, moving along different paths. For example, FIG. 14B shows a source element following a winding path 1406, and in general, from left to right. After the shooting is completed, the seismic data is harvested from the OBNs and processed to form an image of the target. In an embodiment, the processing steps may include parsing the data, correlation, noise removal, stacking the data, data integration, data regularization, move out correction, statics correction, residual statics, deconvolution, and migration. If 4-D processing is required, some form of data differencing may be required. In some instances, the seismic data may be processed to form images using mode-converted S-waves if the OBNs contain 3-C geophones.

In still another embodiment, multiple USVs could operate within the same operational cell so that multiple source elements could be used at the same time to form a source array. The source arrays allow an increase in the acoustic output, which may significantly improve the signal to noise ratio and can allow shorter sweep times to be used to obtain equivalent results as in the case of single source element operation. In some embodiments, the source array directivity can be adjusted to suit a particular need, by varying the phasing of the various vibrator elements within the array.

Having described in the previous embodiments a seismic waves generation system or seismic source system (see, for example, system 400 in FIG. 4A), the next embodiments discuss how such a system may be used to generate an efficient acoustic signal for illuminating a pre-defined geological target. Note that the seismic waves generation systems discussed above are very flexible because of the diversity of source elements used and their variable distribution in space (laterally and in depth). In the context of this embodiment, a source array may be formed by selecting any of the source elements that are deployed through the flotilla of source elements 400. On the other hand, any acquisition design requires a specific distribution of source elements.

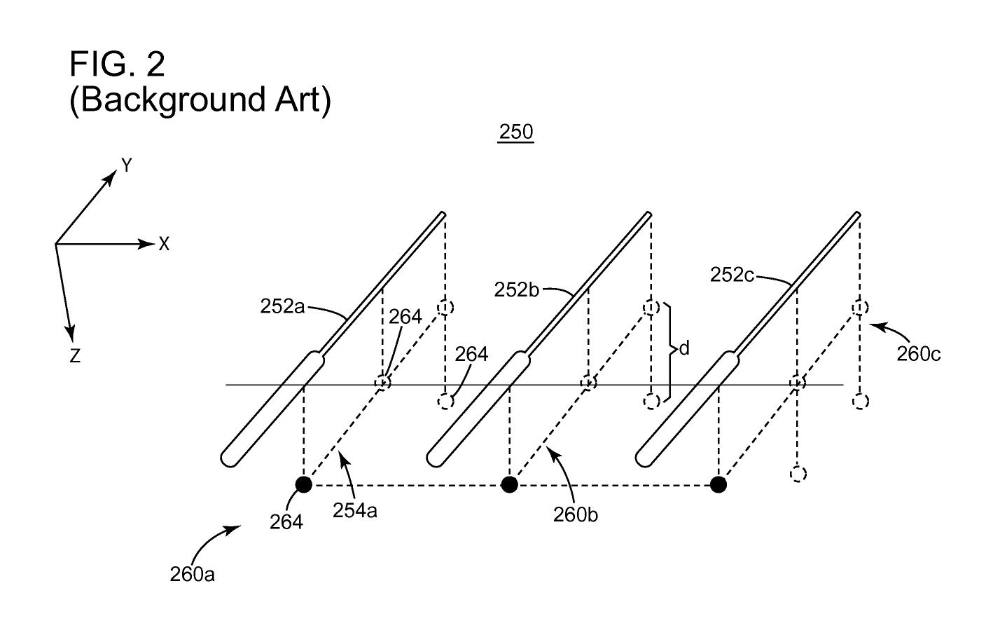

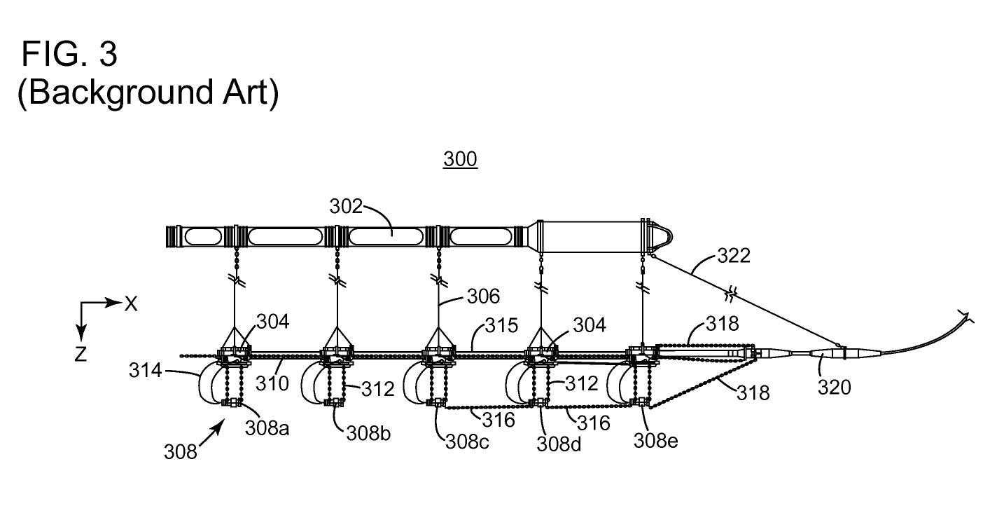

In this embodiment, the source elements of the seismic source system are deployed to obtain an efficient simultaneous source (SimSrc) deployment. The SimSrc deployment assumes that two full source arrays (FSA) are actuated simultaneously. An FSA is traditionally achieved with three sub-arrays that are towed by a single vessel, each sub-array having plural source elements connected to a float as illustrated in FIG. 2. In the following, the FSA is achieved with individual source elements chosen based on various criteria, from the flotilla of source elements.

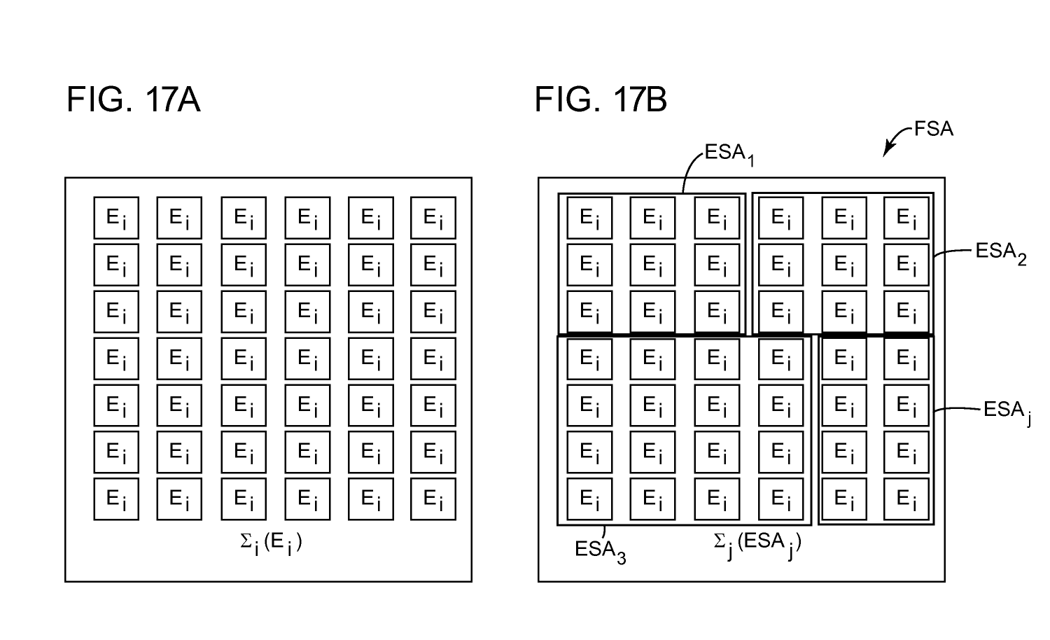

To simultaneously actuate two FSAs, the flotilla has to be large and both FSA have to be encoded (sweep, distance, etc.) in order to be able to separate (deblend) their signals. In the case where emitting the full source signal at once is not the priority, the distribution of the flotilla elements on the field could be optimized for a more efficient SimSrc scenario and the full signal could be reconstructed after deblending the components. Nevertheless, to benefit from array forming potentials, source elements with similar characteristics (e.g., size, emitted frequency spectrum, etc.) could be gathered into Elementary Source Arrays (ESA) and the full signal would be a combination of ESAs as described by:

$$FSA = {\sum }_{j} {ESA}_{j} and$$

$${ESA}_{j} = {\sum }_{i} {E}_{i} ,$$

where each ESAᵢ corresponds to a small flotilla of source elements Eⱼ deployed with a specific geometry that is optimized for specific objectives such as: frequency bandwidth (Low-Frequency, Mid-Frequency, High-Frequency, . . . ), radiation pattern, penetration, “j” is an index for each source element and can vary from 2 to thousands, and “i” is an index for each ESA and can vary from 1 to hundreds. FIG. 17A shows a given number of source elements Eᵢ forming an ESAⱼ, and FIG. 17B shows plural ESAⱼ forming an FSA. Those skilled in the art would understand that each ESAⱼ may be formed in various ways, i.e., they do not have to be rectangles as illustrated in FIG. 17B. The shape of the ESAⱼ may be changed during the seismic survey, for example, from shotpoint to shotpoint. This is possible because the source elements are not physically connected to each other or to a common float, as is the case for a traditional source array.

The deployment in the field of ESA flotillas could be optimized for various SimSrc scenarios: ESAᵢ with no spectral overlap (LF, MF, HF, etc.) could be deployed close to each other; ESAᵢ with spectral overlap could be actuated with orthogonal sweeps; or some ESAᵢ with spectral overlap could be deployed far enough in order to avoid the time overlap. Other scenarios may be implemented by those skilled in the art. In some applications, an ESA may be reduced to a single source element E.

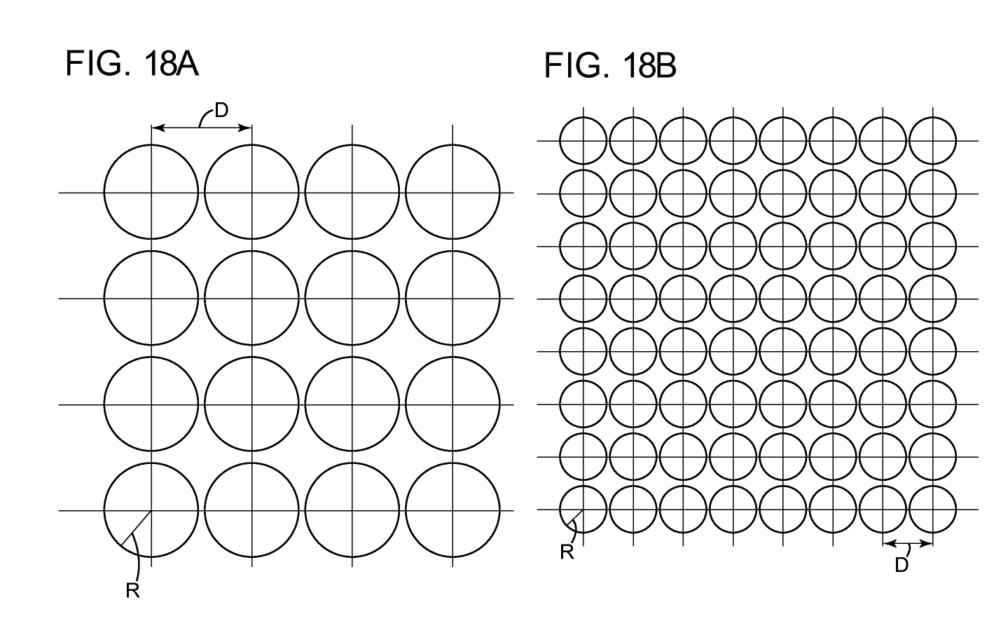

In another embodiment, it is possible to deploy ESAs according to their frequency bandwidth. A distance D between source elements in the acquisition design is calculated to achieve a continuous illumination of a target at a given depth, in relation to the main frequency of the emitted bandwidth. This optimum distance D, in one application, is proportional to the Fresnel zone radius R, which is inverse proportional to the main frequency. FIG. 18A shows the distance D and radius R for LF source elements and FIG. 18B shows the same quantities for HF source elements. It is noted that when the flotilla of source elements is built with ESA components with different frequency bandwidths, the distribution grid of the low-frequency ESA (shown in FIG. 18A) could be sparser than the grid of the high-frequency ESA (shown in FIG. 18B).

The amount of acoustic energy generated by the flotilla and propagating to the subsurface could be amplified by increasing the number of EASs actuating at a given source location or by extending the vibrating time of the same ESA. A controller (global, local or a combination of them) combines (1) the optimum number of ESAs and (2) the vibration length of each ESA with the goal of reaching the required acoustic energy for the necessary signal-to-noise ratio.

Knowing that the seismic data acquired with long offsets (source-receiver distance) contains less high-frequency signals, it is not necessary to actuate the HF source elements along the contour of the acquisition grid (Region A in FIG. 14A). Thus, in one application, the source element locations of an ESA with high-frequency content could be removed from the acquisition preplot. Although the ESA discussed above have combined source elements having the same bandwidth, it is possible to group source elements based on their sweep or other parameters to form an ESA.

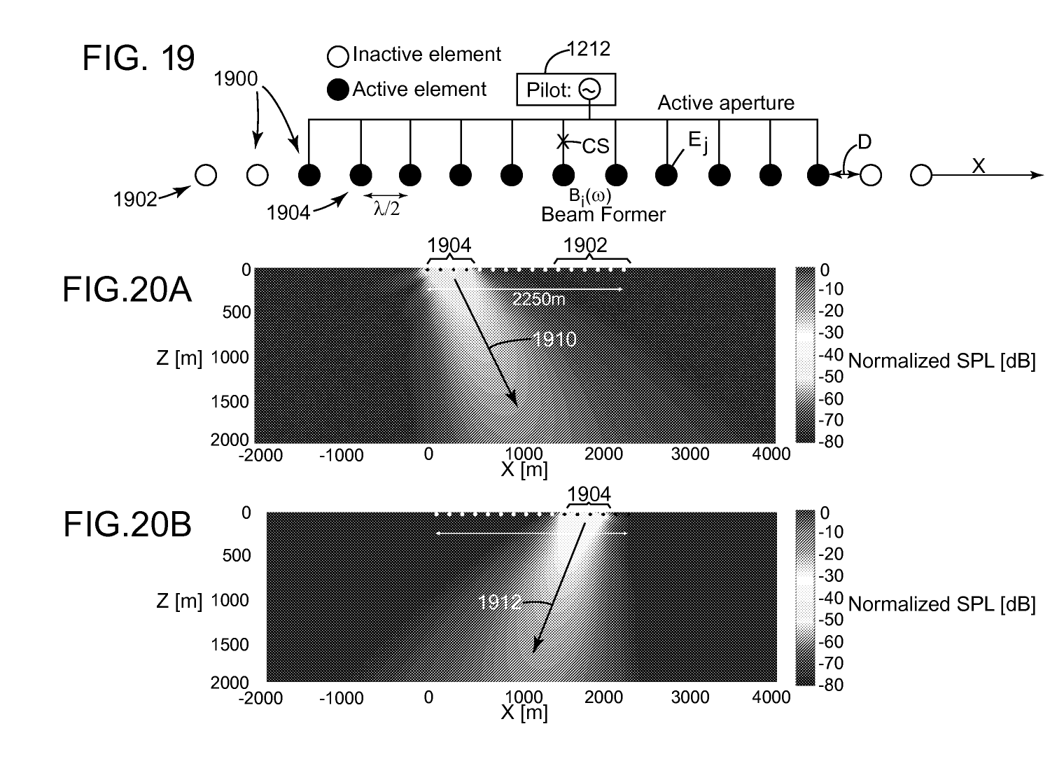

According to another embodiment, illustrated in FIG. 19, a number of source elements Eⱼ could be aligned, for example, along a line X, with a specific distance separation D. This elementary array of source elements 1900 could be tuned to generate a specific signal with a specific beam direction. This specific array forming could be actuated dynamically, with a center source CS moving along the line X of source elements as illustrated in FIG. 19. In other words, consider that there are 200 source elements aligned along line X and 11 of the source elements 1904 are at any given time active, while the other 189 source elements 1902 are inactive. This is simply an example for illustrating the concept and not intended to limit the invention. All the source elements are communicatively connected to source controller 1212 as illustrated in FIGS. 12 and 13. Source controller 1212 instructs at a first instant t1 only 11 source elements, shown as active sources in FIG. 19, to shoot. At a later instant t2, the source controller 1212 instructs another set of 11 source elements to shoot. The set of 11 source elements moves along the line X with a given “speed” (i.e., the CS point moves with this speed while the 200 sources are in fact stationary) while the other set of source elements are inactive. In this way, although the 200 source elements are stationary, the set of 11 active sources appear to advance along line X.

FIG. 20A shows that the array 1900 extends over a large distance, e.g., thousands of meters, and only the set of source elements 1904 generate seismic waves having a given direction 1910. FIG. 20A shows the set of source elements 1904 being located further to the left and sending the seismic waves having a different direction 1912. Thus, in one embodiment, it is possible to have an array of source elements 1900 (as discussed in regard to FIG. 4A) that are distributed along a line X, a set of the source elements 1904 is activated and a center source CS of the set moves along the X line while a direction of the beam emitted by the set of source elements 1902 changes from a first direction 1910 to a second direction 1912. In one application, the first direction 1910 points along one direction of the X line and the second direction 1912 points in an opposite direction of the X line. All this is happening while another set of source elements 1904, of the same array of source elements 1900, is inactive (i.e., not shooting). However, during a given time period, all the source elements of the source array will eventually shoot.

This deployment allows to realize a very dense illumination of the subsurface target along the line X and can be repeated for other beam directions tuned to illuminate the same target but at different angle. In one application, the direction of beams emitted by the sliding set 1904 could be tuned to be identical. If necessary, this operation could be repeated for another beam direction and generating a p-scan of wavefield at emission (p corresponds to plane wave decomposition of seismic wavefield). The acquired seismic data corresponds to a fully controlled spatially dense plane-wave decomposition, which is suitable for advanced subsurface model building techniques such as stereo tomography, where the knowledge of takeoff angle of plane wave at source location, in addition to plane wave decomposition at receiver location, is required.

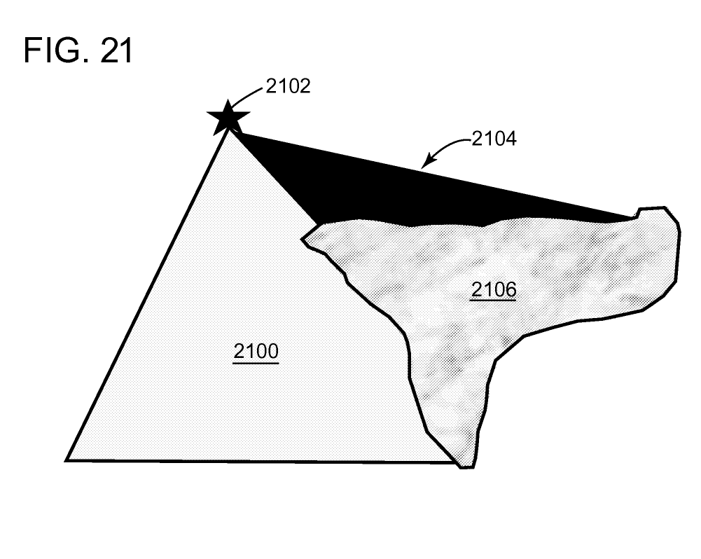

The aligned array of source elements could be laterally spaced to honor a grid of source lines similar to a land seismic acquisition. In some embodiments, the grid may include orthogonal source lines and the source beams could be generated along inline and/or crossline directions accordingly. Due to the flexibility of the source elements noted in FIG. 4A, in one application, the flotilla may be instructed to deploy along specific azimuths according to desired illumination patterns. For example, in one embodiment illustrated in FIG. 21, the beam emission 2100 realized by the aligned array of source elements 2102 could be controlled to avoid the propagation of undesirable waves (refraction, surface waves, etc.) at specific targets 2106 with a strong impedance contrast, so that less energy is propagated in area 2104.

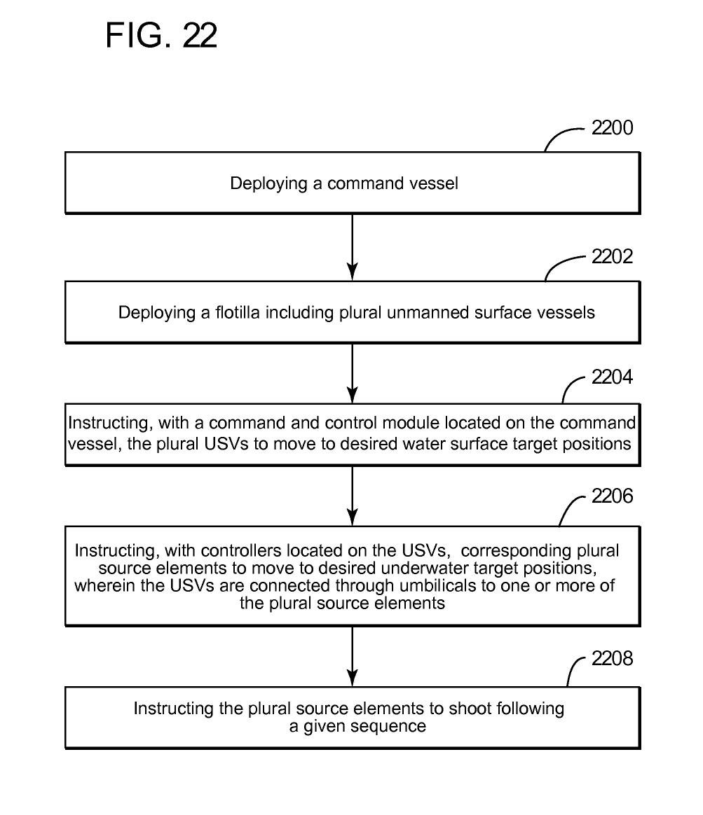

According to an embodiment illustrated in FIG. 22, a method for generating seismic waves in a marine environment may include the following steps. Note that this method takes advantage of the flexibility of the source elements discussed in FIGS. 4 to 5B. The method includes a step 2200 of deploying a command vessel, a step 2202 of deploying a flotilla including plural USVs, a step 2204 of instructing, with a command and control module located on the command vessel, the plural USVs to move to desired water surface target positions, a step 2206 of instructing, with controllers located on the USVs, corresponding plural source elements to move to desired underwater target positions, wherein the USVs are connected through umbilicals to one or more of the plural source elements, and a step 2208 of instructing the plural source elements to shoot following a given sequence. The command and control module 840 controls the shooting positions and shooting times in the given sequence of the plural source elements 414 and/or 424.

In one application, the command and control module communicates in a wireless manner with the USV controllers of the plural USVs for positioning the source elements while the USV controllers communicate in a wired manner (e.g., fiber optic, coaxial cable, etc.), through the umbilicals, with the corresponding source elements for instructing the source elements to adjust their positions relative to the USVs. In one application, the plural source elements include HF source elements connected to HF USVs and LF source elements connected to LF USVs. The plural source elements are not physically connected to each other and each source element moves to a target position independent of the other source elements. In one application, the plural source elements are stationary when shooting. In still another application, the method further includes storing the plural source elements on the plural USVs when the USVs move from one shooting position to another shooting position; deploying the plural source elements at given depths when the USVs are at corresponding shooting points; and retracting the plural source elements to the USVs after shooting.

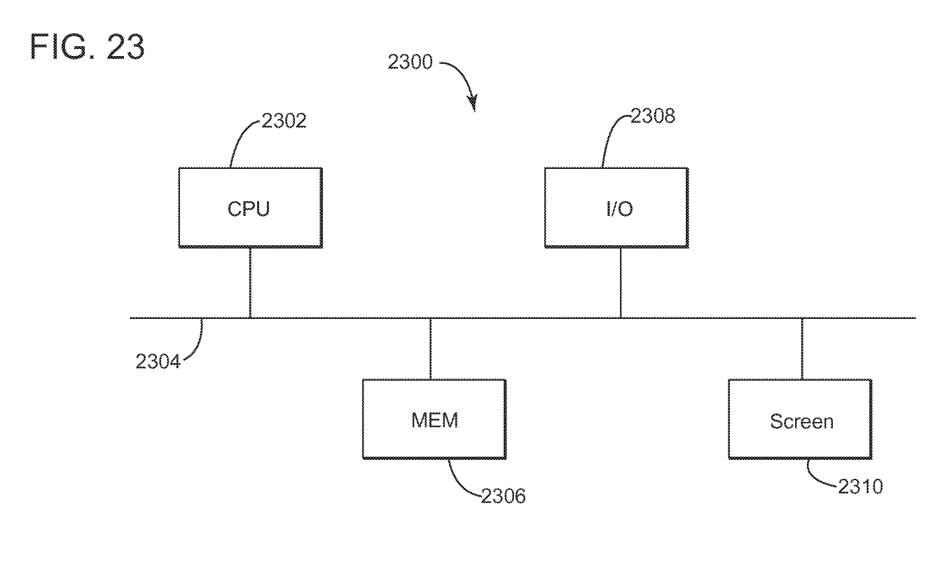

Various controllers and modules have been discussed above. Such controllers may be implemented as illustrated in FIG. 23. Computing device 2300 includes a processor 2302 that is connected through a bus 2304 to a storage device 2306. Computing device 2300 may also include an input/output interface 2308 through which data can be exchanged with the processor and/or storage device. For example, a keyboard, mouse or other device may be connected to the input/output interface 2308 to send commands to the processor and/or to collect data stored in the storage device or to provide data necessary to the processor. Alternatively, input/output interface 2308 may communicate with a transceiver for receiving instructions from another device, e.g., command and control module. The processor may be used to process, for example, position data, shooting data, etc. Results of this or another algorithm may be visualized on a screen 2310, which is attached to controller 2300.

The disclosed embodiments provide a system and a method for providing a dynamic source array. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A seismic source system comprising:
a command vessel;
a flotilla including plural unmanned surface vessels (USVs); and
plural source elements configured to be deployed to a given depth in water to generate seismic waves,
wherein each USV is connected through an umbilical to one or more of the plural source elements, and
wherein the command vessel is configured to control a shooting position and a shooting time of the one or more of the plural source elements.

2. The system of claim 1, wherein the command vessel comprises a command and control module that is configured to orchestrate the shooting positions and the shooting times of all the plural source elements.

3. The system of claim 2, wherein the plural USVs comprise USV controllers and the command and control module is configured to communicate in a wireless manner with USV controllers of the plural USVs for positioning the plural source elements.

4. The system of claim 3, wherein the USV controllers are configured to communicate in a wired manner, through the umbilicals, with corresponding source elements of the plural source elements for instructing the corresponding source elements to adjust their positions.

5. The system of claim 1, wherein the plural source elements include high-frequency (HF) source elements connected to HF USVs and low-frequency (LF) source elements connected to LF USVs.

6. The system of claim 1, wherein the plural source elements are not physically connected to each other and each source element is configured to move to a target position independent of the other source elements.

7. The system of claim 1, wherein the plural source elements are stationary when shooting.

8. The system of claim 1, wherein each source element is housed in a corresponding frame that has an independent propulsion system.

9. The system of claim 8, wherein the independent propulsion system of the frame is configured to position the source element relative to the corresponding USV.

10. The system of claim 8, wherein the USV is configured to tow the source element to a surface target position, and the independent propulsion system of the source element is configured to adjust an underwater position of the source element to be close to the target underwater position.

11. The system of claim 8, wherein the source element is configured to pivot relative to the frame.

12. The system of claim 1, wherein an USV of the plural USVs is configured to store inside a corresponding source element, and to deploy the source element to a target depth when arriving at a given position.

13. The system of claim 12, wherein the USV is configured to retract inside the corresponding source element and move the source element to a new target position.

14. A method for generating seismic waves in a marine environment, the method comprising:
deploying a command vessel that comprises a command and control module;
deploying a flotilla including plural unmanned surface vessels (USVs) that comprise USV controllers;
instructing, with the command and control module, the plural USVs to move to desired water surface target positions;
instructing, with USV controllers, corresponding plural source elements to move to desired underwater target positions, wherein the USVs are connected through umbilicals to one or more of the plural source elements; and
instructing the plural source elements to shoot according to a given sequence,
wherein the command and control module controls shooting positions and shooting times in the given sequence of the plural source elements.

15. The method of claim 14, wherein the command and control module communicates in a wireless manner with the USV controllers of the plural USVs for positioning the source elements.

16. The method of claim 15, wherein the USV controllers communicate in a wired manner, through the umbilicals, with the corresponding source elements of the plural source elements for instructing the corresponding source elements to adjust their positions relative to the USVs.

17. The method of claim 14, wherein the plural source elements include high-frequency (HF) source elements connected to HF USVs and low-frequency (LF) source elements connected to LF USVs.

18. The method of claim 14, wherein the plural source elements are not physically connected to each other and each source element moves to a target position independent of the other source elements.

19. The method of claim 14, wherein the plural source elements are stationary when shooting.

20. The method of claim 14, further comprising:
storing the plural source elements on the plural USVs (410, 420) when the USVs move from one shooting position to another shooting position;
deploying the plural source elements at given depths when the USVs are at corresponding shooting points; and
retracting the plural source elements to the USVs after shooting.
